(19) United States
(12) Patent Application Publication
(10) Pub. No.: US 2014/0172544 A1
(43) Pub. Date: Jun. 19, 2014

(54) USING NEGATIVE FEEDBACK ABOUT ADVERTISEMENTS TO SERVE ADVERTISEMENTS

(71) Applicant: Facebook, Inc., Menlo Park, CA (US)

(72) Inventor: Mark Rabkin, Palo Alto, CA (US)

(73) Assignee: Facebook, Inc., Menlo Park, CA (US)

(21) Appl. No.: 13/717,510

(22) Filed: Dec. 17, 2012

(51) Int. Cl. G06Q 30/02

(52) U.S. Cl. CPC G06Q 30/0245
USPC 705/14.44

(57) ABSTRACT

A social networking system stores a plurality of objects and displays advertisements related to the objects to users of the system. If a user dislikes an advertisement, the user may provide explicit negative feedback for the advertisement. When the social networking system receives the negative feedback, a list of reasons for the user's dislike is presented to the user, who may select one or more of the reasons. If the user selects a user-specific reason, the object represented by the advertisement is added to a negative interests list for the user. If the user selects an advertisement-specific reason, the negative feedback is used to determine a quality score for the advertisement.

### BACKGROUND

This invention relates generally to social networking, and in particular to negative signals received from users of social networking systems.

A social networking system stores social information about users, including their social profiles and social interactions. Social networking systems also provide users with the ability to interact with a number of different objects within the system. The social networking systems can provide customized information about the objects to the users, attempting to display information that the user is interested in. This information may be displayed in the form of advertisements.

The users' interests may be determined based on their activity within the social networking system. However, many of the ways a social networking system can determine a user's interests rely on positive signals. That is, users may only indicate through their actions on the system that they are interested in a particular object, but not that they are uninterested in or offended by an object. By providing users with the ability to supply negative feedback associated with an object, the social networking system can provide information to its users that is more relevant to their interests. Furthermore, the social networking system can use negative feedback to learn about the advertisements themselves and refine the targeted delivery of the advertisements based on the learned information.

### SUMMARY

Embodiments of the invention provide methods for processing negative signals associated with advertisements in a social networking system. Users who provide negative signals are requested to provide a reason for their lack of interest in the advertisement. Based on whether the reason is indicative of characteristics of the user or characteristics of the advertisement, the social networking system augments the user's profile or the advertisement.

In one embodiment, users are presented with a set of reasons offering a potential explanation for why the user disliked the advertisement. Each reason is categorized as user-specific or advertisement-specific. If the user selects a reason that is user-specific, the social networking system augments the user's profile by adding an object represented by the advertisement to a negative interests list of the user. The social networking system may reduce the number of advertisements associated with objects on the negative interests list that are delivered to the user.

If the user selects a reason that is advertisement-specific, the social networking system augments the advertisement by using the negative feedback to determine a quality score for the advertisement. The quality score may be used to determine whether to deliver the advertisement to other users of the social networking system. In one embodiment, the system determines common characteristics of users who dislike the advertisement, finds a second set of users having the same characteristics, and determines whether to deliver the advertisement to the users based on their inclusion in the second set. In one embodiment, the quality score for an advertisement is determined based on the components of the advertisement. Other advertisements having the same component are identified, and the quality score of the other advertisements is decreased based on the negative feedback associated with the component.

The features and advantages described in this summary and the following detailed description are not all-inclusive. Many additional features and advantages will be apparent to one of ordinary skill in the art in view of the drawings, specification, and claims. For example, although embodiments of the invention are discussed with reference to a social networking system, embodiments of the invention may be used with other online systems.

### BRIEF DESCRIPTION OF THE DRAWINGS

FIG. 1 is a diagram of a system environment illustrating a social networking system, according to one embodiment.

FIG. 2 is a high-level block diagram of the system architecture of a social networking system for processing negative signals associated with advertisements, according to one embodiment.

FIG. 3 is a diagram illustrating an advertisement hierarchy, according to one embodiment.

FIG. 4 is an illustration of an advertisement with various components, according to one embodiment.

FIG. 5 is a block diagram illustrating modules within a negative feedback module, according to one embodiment.

FIG. 6 is an illustration of a user interface enabling users to provide a reason for negative feedback, according to one embodiment.

FIG. 7 is a flow diagram illustrating a method for processing negative feedback associated with advertisements, according to one embodiment.

FIG. 8 is a flow diagram illustrating a method for determining a cluster of users who dislike an advertisement, according to one embodiment.

FIG. 9 is a diagram illustrating a reasons hierarchy, according to one embodiment.

FIG. 10 is a flow diagram illustrating a method for determining detailed reasons for user disinterest in an advertisement, according to one embodiment.

FIG. 11 is a flow diagram illustrating a method for identifying users for advertisement delivery based on negative feedback associated with components of the advertisement, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

A social networking system offers its users the ability to communicate and interact with other users of the social network. In use, users join the social network and then add connections to a number of other users to whom they desire to be connected. As used herein, the term “friend” refers to any other user to whom a user has formed a connection, association, or relationship via the social network. Connections may be added explicitly by a user, for example, the user selecting a particular other user to be a friend, or automatically created by the social network based on common characteristics of the users (e.g., users who are alumni of the same educational institution). Connections in social networking system are usually bidirectional, but need not be, so the terms “user” and “friend” depend on the frame of reference. For example, if Bob and Joe are both users and connected to each other in the social networking system, Bob and Joe, both users, are also each other's friends. A connection between users may be a direct connection; however, in some embodiments, a connection between users may be indirect via one or more levels of connections. Also, the term “friend” need not require that users actually be friends in real life (which would generally be the case when one of the users is a business or other entity), but is used herein to indicate a connection in the social networking.

A social networking system provides various mechanisms to its users to communicate with each other and to obtain information about their connections that they might find interesting, such as activities that their friends are involved with, applications that their friends are installing, and comments made by friends on activities of other friends. These mechanisms include email, notifications, newsfeeds, and the like. For example, a newsfeed provides to a user a constantly updated list of activities of the user's friends. The social networking system may post information related to a user's activities on the social network and make the information available to the user's friends on the social network.

In addition to interactions with other users, the social networking system provides users with the ability to take actions on various types of items supported by the social networking system. These items may include groups or networks (where “networks” here refer not to physical communication networks, but rather to social networks of people) to which users of the social networking system may belong, events or calendar entries in which a user might be interested, computer-based applications that a user may use via the social networking system, and transactions that allow users to buy, sell, auction, rent, or exchange items via the social networking system. These are just a few examples of the items that may be supported by the social networking system, and many others are possible. The record of users, supported items, and connections between them in the social networking system may be called a “social graph.”

The social graph includes nodes connected by edges that are stored on a social networking system. Nodes include users and objects of the social networking system, such as web pages embodying concepts and entities, and edges connect the nodes. Edges represent a particular interaction between two nodes, such as when a user expresses an interest in a web page about a particular bar or restaurant. The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes of the graph objects and graph actions. U.S. patent application Ser. No. 12/763,171, filed Apr. 19, 2010, which is incorporated by reference in its entirety, describes example social graph structures that may be used in various embodiments of the present invention.

Social networking systems store information describing users of the social networking system. Actions of the users within the system can affect the information that is displayed to them. For example, users may post information, visit pages, or interact with information posted by others in the social networking system. Alternatively, users may visit and interact with Web pages outside of the social networking system that contain plug-ins for that social networking system.

Many of the signals used to determine advertisements to display to a user of the social networking system are positive signals. That is, an action taken by the user indicates the user's interest in a particular object. For example, if a user visits a particular page, it is likely that the user is interested in content of the page. An alternative method for determining a user's interests relies on negative signals, which indicate a user's disinterest in an object.

### System Environment

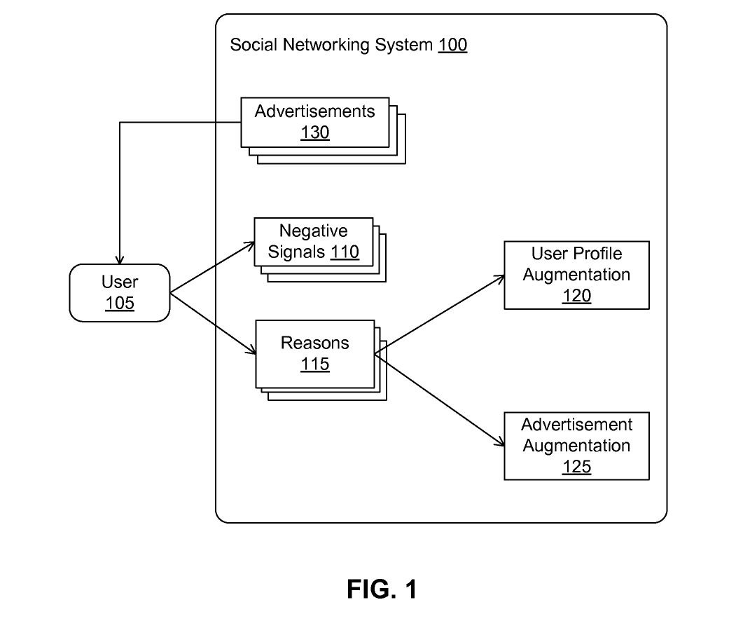

FIG. 1 is a diagram of a system environment illustrating a social networking system using negative signals to characterize advertisements and augment user profiles. FIG. 1 illustrates interactions between a social networking system 100 and a user 105.

The social networking system 100 may include a website, comprising a computing system that allows users to communicate or otherwise interact with each other and access content as described herein. The social networking system 100 maintains a number of objects for the different kinds of items with which a user may interact on the website. For example, these objects may include user profiles, group objects, event objects, applications objects, and transaction objects. In one embodiment, an object is stored by the social networking system 100 for each instance of its associated item. For example, a user profile is stored for each user who joins the social networking system 100.

A user of the social networking system 100 may take specific actions within the social networking system 100, where each action is associated with one or more objects. The type of actions that a user may perform in connection with an object is defined for each object and largely depends on the type of item represented by the object. A particular action may be associated with multiple objects. Described below are a number of examples of particular types of objects that may be defined for the social networking system 100, as well as a number of actions that can be taken for each object. These objects and the actions discussed herein are provided for illustration purposes only, and it can be appreciated that an unlimited number of variations and features can be provided by a social networking system 100.

One way that a user may interact with objects in the social networking system 100 is through advertisements. In one embodiment, advertisements 130 are displayed within controlled ad medium pages, such as web pages, social networking system pages, and the like. For example, advertisements 130 may be displayed to the user 105 within the social networking system 100 through a newsfeed, a side panel, a pop-up notification, a push notification, or a native mobile application. Alternatively, the social networking system 100 may serve ads to external platforms. For example, the social networking system 100 may route messages to a client device of the user 105 by instant messages, queued messages, text and short message service (SMS) messages, or the social networking system 100 may provide API functionality to send data directly to native client device operating systems. A method for presenting advertisements through an application executing on a mobile device is described in U.S. application Ser. No. 13/689,160, entitled “Targeted Advertisements in Mobile Applications,” filed Nov. 29, 2012, and a method for delivering advertisements across platforms is described in U.S. application Ser. No. 13/354,849 entitled “Cross-Medium Advertising Network,” filed Jan. 20, 2012, both of which are incorporated herein by reference in their entirety.

Advertisements 130 may be any item displaying information to a user about objects within or external to the social networking system, such as third-party product promotions, game requests, pages within the social networking system, events, actions of other users within the social networking system, or other applications. Users may interact with the advertisements 130 by following links embedded in the advertisement or by clicking on a selectable user interface element, such as a button, indicating an interest or disinterest in the advertisement.

As a user interacts with the objects in the social networking system 100, some of the objects will be interesting to the user and some objects will be uninteresting or offending to the user. A user may wish to view more advertisements associated with some objects and fewer advertisements associated with other objects. As a result, a user may wish to supply positive or negative feedback associated with an object.

The reasons for indicating negative feedback can be highly varied. For example, advertisements may include information about applications in which the user is not interested, such as games that can be installed and played by users of the social networking system. Advertisements may include offensive images. Information included in the advertisement may not be relevant to a user in a given geographic region, such as advertisements for restaurants that are not in proximity to a user's location. Advertisements may promote political views opposing those of a user. Alternatively, advertisements may include information that is interesting to the user and a link to an external website, but the link may point to a page that no longer exists.

In one embodiment, the user may supply explicit negative feedback for an advertisement by clicking on an “x” located on or near an advertisement 130. After clicking on the “x,” the social networking system 100 may remove the advertisement 130 from the user's newsfeed, “hiding” it from the user. In one embodiment, the social networking system 100 records the clicked “x” as negative feedback associated with the advertisement 130. When a user 105 supplies a negative signal 110 for a particular advertisement 130, the negative signal may be applied in different places throughout the social networking system 100. In one embodiment, a negative signal 110 is used to augment the profile of the user who supplied the signal, the advertisement 130 associated with the signal, or both.

When a negative signal 110 is used to learn information about the advertisement 130, the social networking system 100 may in one embodiment present the user with reasons 115 that indicate why the user provided the negative feedback. The reasons 115 that are presented to users may be selected from a set of reasons stored by the social networking system 100, based on reasons chosen by previous users. Each reason is categorized as user-specific or advertisement specific, or both. For example, the reasons 115 may include “uninteresting,” “against my views,” “sexually explicit,” and “offensive.” “Uninteresting” and “against my views” may be categorized as user-specific reasons, “sexually explicit” may be categorized as an ad-specific reason, and “offensive” may be categorized as both. The user is given the option to select one or more of the reasons as an explanation for the negative feedback. If a user selects a reason 115 that is user-specific (e.g., “The ad is uninteresting”), the social networking system 100 augments the user's profile with a negative attribute. In one embodiment, user profile augmentation 120 comprises adding the object represented by the advertisement to a negative interests list for the user.

Alternatively, if a user chooses a reason 115 that is advertisement-specific (e.g., “The ad is sexually explicit”), the social networking system 100 may use the chosen reason to augment the advertisement with a negative attribute. In one embodiment, advertisement augmentation 125 comprises determining a quality score for the advertisement 130, based in part on the negative signals 110. The social networking system 100 may use the quality score of an advertisement 130 in determining whether to deliver the advertisement to particular users.

### System Architecture

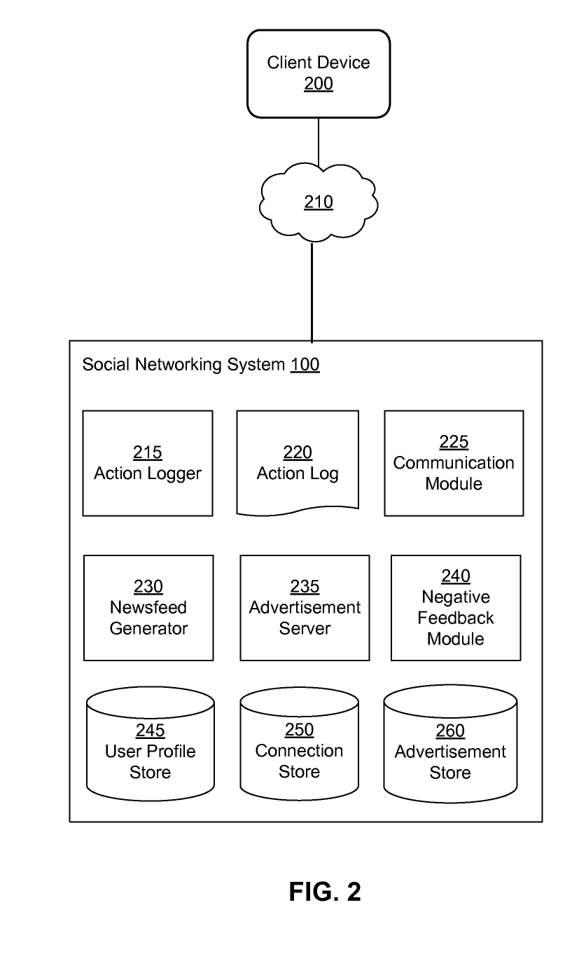

FIG. 2 is a high-level block diagram of the system architecture of a social networking system for processing negative signals associated with advertisements 130, in accordance with an embodiment of the invention. The system architecture may be configured as computer-executable program modules. As used herein, the term “module” refers to computer program logic and/or data for providing the specific functionality. A module can be implemented in hardware, firmware, and/or software. The social networking system 100 includes an action logger 215, an action log 220, a communication module 225, a newsfeed generator 230, a negative feedback module 240, a user profile store 245, a connection store 250, and an advertisement store 260. In other embodiments, the social networking system 100 may include additional, fewer, or different modules for various applications. Conventional components such as network interfaces, security mechanisms, load balancers, failover servers, management and network operations consoles, and the like are not shown so as to not obscure the details of the system.

A client device 200 interacts with social networking system 100 through network 210, which is a communication pathway between a user device 200, a merchant system 205, and the social networking system 100. The network 210 is typically the Internet, but may be any network, including but not limited to a LAN, a MAN, a WAN, a mobile wired or wireless network, a private network, or a virtual private network. In one embodiment, the network 210 uses standard communications technologies and/or protocols. For example, the networking protocols used on the network 210 can include the transmission control protocol/Internet protocol (TCP/IP), the hypertext transport protocol (HTTP), the file transfer protocol (FTP), etc. The data exchanged over the network 210 can be represented using technologies and/or formats including the hypertext markup language (HTML), the extensible markup language (XML), etc. In some embodiments, the entities can use custom and/or dedicated data communications technologies instead of, or in addition to, the ones described above.

The client device 200 can be a desktop computer, laptop computer, portable computer, personal digital assistant (PDA), smart phone, or any other device including computing functionality and data communication capabilities. A plurality of client devices 200 can be configured to communicate via the network 210. Furthermore, although only one client device is shown in FIG. 2 for simplicity, it is to be understood that a plurality of client devices may interact with social networking system 100.

The action logger 215 identifies interactions of users with social networking system 100 and logs the information in action log 220. User interactions with social networking systems include interactions between users, interactions between a user and a page within the social networking system, interactions between a user and a post on a page, and user visits to or interactions with a page outside the social networking system that contains plug-ins for that social networking system. When a user manually enters information into the user's profile, for example, name, location, sex, age, and date of birth, the information is stored in the user profile store 245.

In one embodiment, the social networking system 100 maintains the action log 220 as a database of entries. When an action is taken on the social networking website, therefore, the social networking system adds an entry for that action to the log 220. As a result, the action log 220 is populated with a number of entries describing actions taken by users. The action log 220 thus contains a rich set of data about the actions of the users, and can be analyzed and filtered to identify trends and relationships in the actions of the users as well as affinities between the users and the various objects.

The communication module 225 provides various methods for users to communicate, including but not limited to wall posts, news feed, emails, or customized user interfaces such as side bars or fly-outs. The connection store 250 stores information relating to the social connections of each user such as a list of social connections, list of connections shared with each connection, and frequency and type of interactions between the user and each connection. The communications between the target user and the target user's connections may be stored in the connection store 250 or in a different data store.

For one given user, the information stored in action log 220, user profile store 245, and connection store 250 may be used to accurately predict characteristics of that user, such as their demographic identification, location of residence, political or religious views, interests, or hobbies. For example, the user profile store 245 may maintain a positive interests list and a negative interests list for the user, each including, respectively, items supported by the social networking system that the user is interested in and not interested in.

The newsfeed generator 230 generates communications for each user about information that may be relevant to the user. These communications may take the form of stories, with each story being an information message comprising one or a few lines of information about an action in the action log that is relevant to the particular user. The stories are presented to a user via one or more pages of the social networking website, for example in each user's home page or newsfeed page. A story is a message that summarizes, condenses, or abstracts one or more user actions from the action log 220. The generated newsfeed stories can then be transmitted to one or more related users (e.g., the user's friends), allowing the user's actions to be shared with related users.

The advertisement store 260 stores the advertisements 130. As used herein, an advertisement is any item displayed to users of the social networking system providing information about an object in the social graph. For example, an advertisement may be a story generated for the newsfeed or an informational box displayed adjacent to the newsfeed. The advertisements may be generated by the social networking system in response to user activities (e.g., visiting pages, checking in, installing and using applications, interacting with other users, or supplying positive or negative feedback associated with various objects). Alternatively, the advertisements may be provided by systems external to the social networking system, such as external merchants or third party advertising organizations.

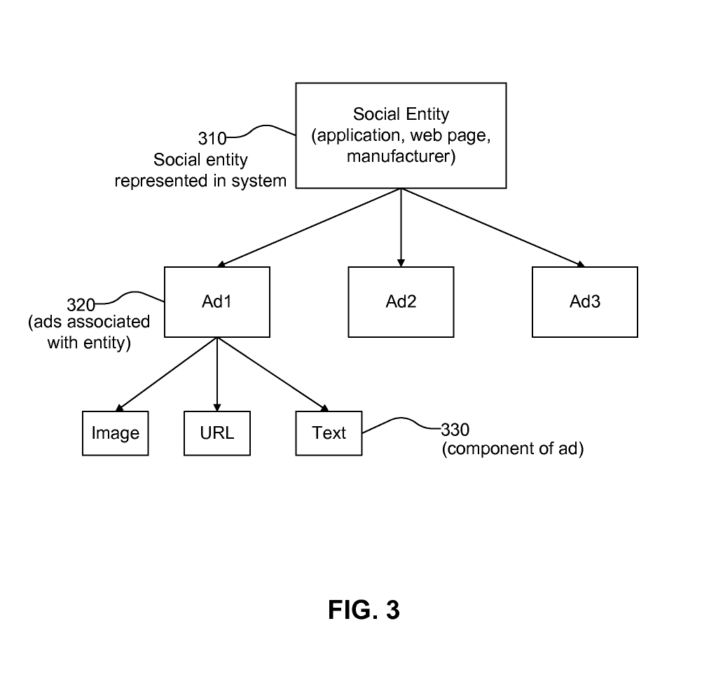

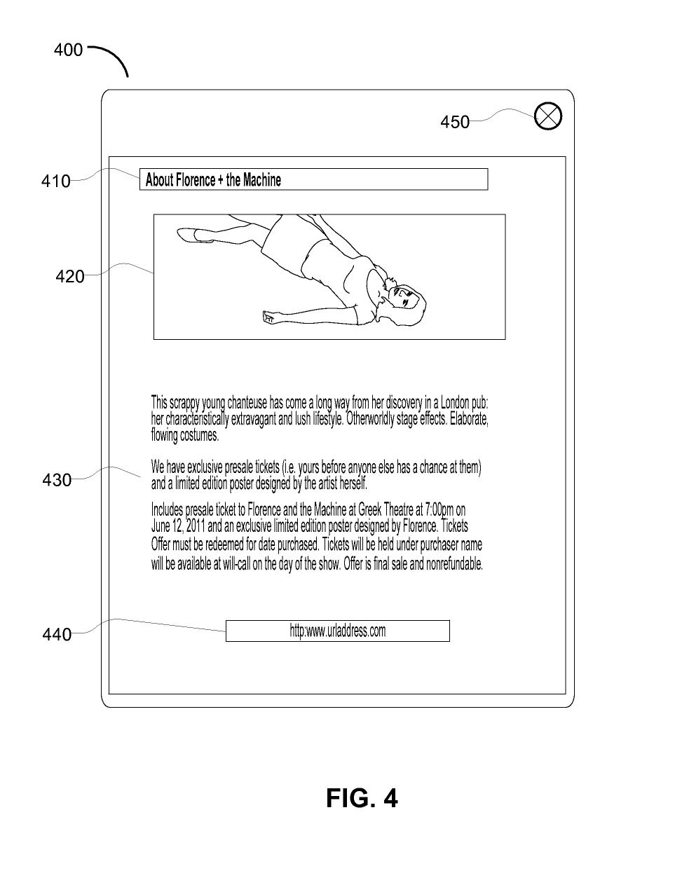

FIG. 3 is a block diagram illustrating an advertisement hierarchy. A social entity 310 may be any object supported by the social networking system 100. For example, the social entity 310 may be an application, a web page, or a manufacturer. A number of ads 320 may be generated for the entity 310. Each ad 320 has various components 330, which may include an image, a URL, or text. In one embodiment, the hierarchy illustrated in FIG. 3 may have additional levels. For example, multiple entities 310 may be associated with the same entity, such as multiple games distributed by the same game developer. An advertisement 400 is illustrated in FIG. 4 as an example of an ad 320, demonstrating a title 410, an image 420, text 430, and a URL 440. In other embodiments, an advertisement can have different components than those illustrated in FIG. 4. The “x” 450 is a link that, when clicked on by a user, hides the advertisement 400. The social networking system 100 registers the selection of the link as explicit negative feedback for the advertisement 400.

An advertisement server 235 is communicatively coupled to the user profile store 245, action log 220, and advertisement store 260. The advertisement server 235 selects advertisements from the advertisement store 260 based on data from the user profile store 245 and/or the action log 220 to present to the user. Hence, the advertisement server 235 uses data from a user's profile and a user's prior actions to determine whether an advertisement is relevant to the characteristics and actions of the user. In one embodiment, the advertisement server 235 determines whether to deliver an advertisement to a user based on a quality score of the advertisement. The quality score, which in one embodiment is a value between 0 and 1, indicates the likelihood of a user having a positive interaction with the advertisement. The quality score may be adjusted for various users of the social networking system 100 based on characteristics of the users. For example, if an advertisement has a quality score of 1 for a particular user characteristic, the users having the characteristic are very likely to be interested in the advertisement. In one embodiment, the quality score is determined based in part on negative feedback associated with the advertisement.

When a user supplies explicit negative feedback for an advertisement, results of the feedback may be propagated differently to the user, related users, and the advertisement itself. That is, the negative feedback may be used to augment a user's profile or to determine a quality score for the advertisement, or both. The negative feedback module 240 processes the negative feedback and determines whether the feedback is applicable only to the user who supplied the feedback, to users sharing a particular characteristic with the supplying user (e.g., friends, users of a similar demographic), or to the entire set of users of the social networking system 100. The negative feedback module 240 uses the processed feedback to produce simultaneous but differing results across the social networking system 100.

### User Profile Augmentation

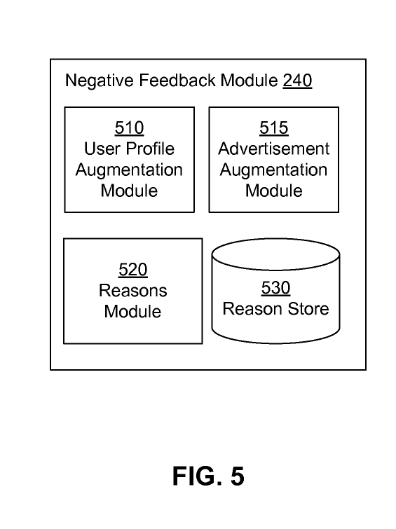

FIG. 5 is a block diagram illustrating modules within the negative feedback module 240. In one embodiment, the negative feedback module 240 includes a user profile augmentation module 510, an advertisement augmentation module 515, a reasons module 520, a component identification module 525, and a reason store 530. Other embodiments of the negative feedback module 240 include different and/or other modules than those described here, and the functionalities can be distributed among the modules in a different manner.

Advertisements are presented to users of the social networking system 100. A set of users of the social networking system may provide explicit negative feedback for the same advertisement. However, each individual user may have a unique reason for providing the negative feedback. For example, one user may be offended by an image in the advertisement, another by the object represented the advertisement, and another with advertisements per se. By requesting that users provide more detailed information than a binary interest or disinterest in an advertisement, the social networking system 100 can learn useful correlations regarding features of advertisements and characteristics of users who are not interested in the advertisements. The correlations can be used to determine whether to deliver a particular advertisement to a particular user of the social networking system.

To obtain more detailed explanations for why users indicate a dislike of an advertisement, the reasons module 520 generates a list of reasons to be displayed to users responsive to receiving their negative feedback. In one embodiment, possible reasons for user disinterest in an advertisement are stored in a reason store 530. Each reason is labeled as being user-specific, advertisement-specific, or applicable to both the user and the advertisement.

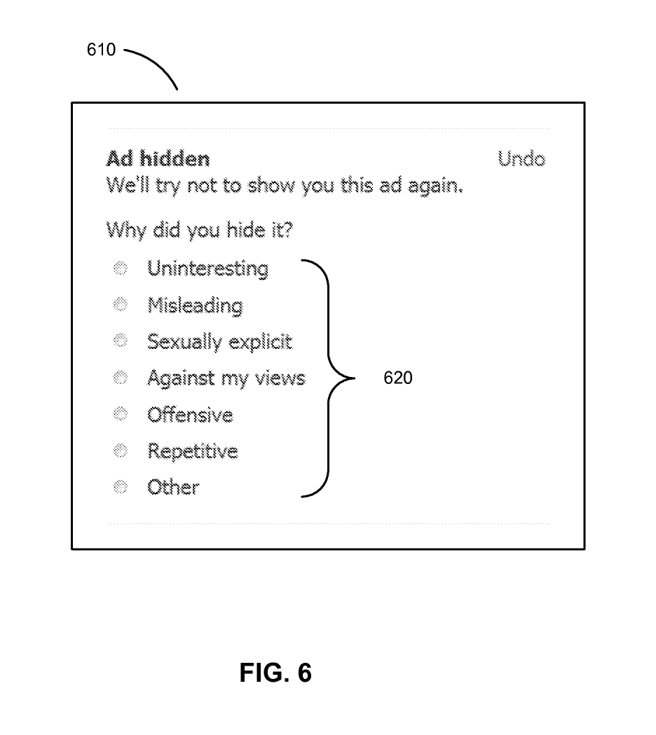

The reasons module 520 determines a subset of the reasons in the reason store 530 to present to a user who supplied an explicit negative signal for an advertisement and sends the list for presentation to the user. FIG. 6 illustrates a user interface 610 generated by the reasons module 520 that enables a user to view the list of reasons 620 and select one as an explanation for the negative signal. A user may select one of the radio buttons displayed on the interface 610 to choose the reason corresponding to the button. For the reasons 620 illustrated in FIG. 6, “uninteresting” and “against my views” may be categorized as user-specific reasons, while “misleading,” “sexually explicit” and “repetitive” may be categorized as advertisement-specific. “Offensive” may be categorized as advertisement-specific, or both user-specific and advertisement-specific. In other embodiments, different reasons besides those illustrated in FIG. 6 may be presented to users, and the reasons may be presented with check boxes or other interface tools to enable a user to select more than one reason.

The user to whom the user interface 610 is displayed may select one or more of the presented reasons 620 as an explanation for hiding the advertisement. The reasons module 520 receives user selections of reasons and, based on whether the selected reason is user-specific or advertisement specific, determines whether to apply the negative signal to the user or to the advertisement. If the user selects a reason for hiding an advertisement 320 that is user-specific, the user profile augmentation module 510 augments the user's profile by adding the object(s) 310 represented by the advertisement to a negative interests list for the user. In one embodiment, the social networking system 100 reduces the rate at which advertisements associated with the objects on the negative interests list are displayed to the user. In another embodiment, the social networking system 100 increases the cost for advertisers to deliver ads to a user that are associated with objects on the user's negative interests list. The social networking system 100 may also add the object(s) 310 to a negative interests list of one or more friends of the user who supplied the negative feedback. For example, the user may be connected to a friend who recently joined the social network and/or has little information in his profile. Based on the friend's connection to the user, the social networking system 100 may infer the friend's disinterest in an advertisement based on the user's disinterest in the ad.

On the other hand, if the user selects a reason for hiding the advertisement that is advertisement-specific, the advertisement is augmented based on the negative feedback and information derived therefrom, as will be described in further detail below. In one embodiment, the social networking system 100 reduces the rate at which the advertisement is displayed to the users of the system 100. In another embodiment, the social networking system 100 increases the cost for advertisers to deliver an advertisement that has received advertisement-specific negative feedback. Additionally or alternatively, an advertiser may be notified when a threshold number of advertisement-specific negative responses have been supplied for one of their advertisements.

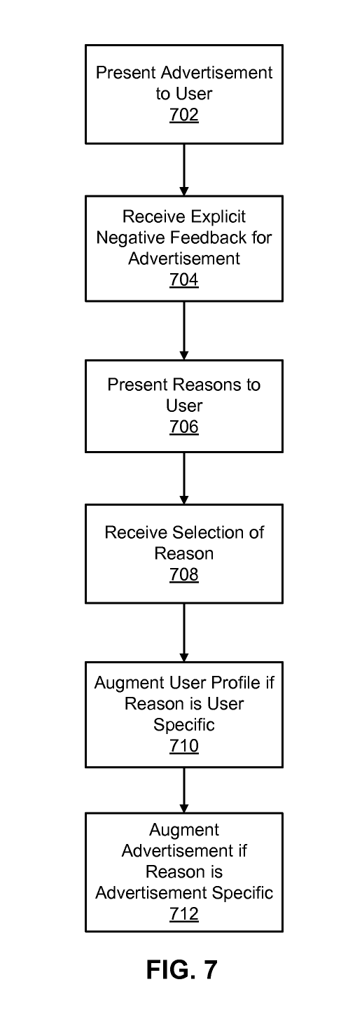

FIG. 7 is a flowchart illustrating a method for augmenting a user's profile, an advertisement, or both based on explicit negative feedback received from a user. The social networking system 100 presents 702 an advertisement to a user. The advertisement may be displayed, for example, as a story in the user's newsfeed on a browser or in a native mobile application, in an advertising panel next to the user's newsfeed, through a notification, or on a third-party website displaying ads served by the social networking system 100. Explicit negative feedback associated with the advertisement is received 704 from the user. In response to receiving the negative feedback, the social networking system 100 presents 706 to the user one or more reasons for the negative feedback. The reasons may be categorized according to whether they are user-specific or advertisement-specific. For example, “against my views” may be a user-specific reason presented by the social networking system, and “sexually explicit” may be an advertisement-specific reason.

The user may then select a reason for providing the negative feedback. The social networking system 100 receives 708 the reason selected by the user, and if the selected reason is user-specific the user's profile is augmented 710 to include the negative feedback. Alternatively, if the selected reason is advertisement-specific, the advertisement is augmented 712 with the negative feedback. In one embodiment, the augmentation of an advertisement comprises using the negative feedback to determine a quality score for an advertisement. The advertisement server 235 may use the quality score to determine a set of users to whom the advertisement is to be presented. In one embodiment, the quality is improved by identifying characteristics of users who provide negative feedback. The characteristics can be used to determine a cluster of other users of the social networking system 100 who share the characteristics and therefore are likely to also dislike the advertisement.

### Advertisement Augmentation

If the reason selected for hiding an advertisement is advertisement-specific, the advertisement augmentation module 515 illustrated in FIG. 5 augments the advertisement based on the negative feedback. In one embodiment, the advertisement augmentation module 515 augments the advertisement with a quality score between 0 and 1 that is calculated based on the negative feedback. An advertisement quality score may be determined in a number of ways. By one method, a new advertisement is initially assigned a quality score of 1. As negative feedback is received from users, the advertisement augmentation module 515 decreases the quality score by a fixed amount. For example, the score may be decreased by 0.01 for every ten thousand negative signals received.

In one embodiment, the advertisement augmentation module 515 determines different quality scores for advertisements for different user characteristics. The advertisement augmentation module 515 identifies common characteristics of a group of users who provide negative feedback for an advertisement. A cluster of users having similar characteristics is determined based on the common characteristics, and the advertisement augmentation module 515 assigns a quality score to the advertisement that is specific to the users in the cluster. For example, an advertisement for a home renovation service may frequently receive negative signals from users under the age of eighteen. The advertisement augmentation module 515 may assign the advertisement a quality score of 0.2 for users whose profile indicates that their age is under eighteen, but assign a quality score of 0.8 for users who are over the age of eighteen.

In one embodiment, the advertisement augmentation module 515 determines characteristics shared by the group of users who provided negative feedback by determining the number of times an advertisement is hidden by users having a particular characteristic, relative to the number of users to whom the advertisement was delivered. The advertisement augmentation module 515 may retrieve information about the users to whom the advertisement was displayed, the number of negative signals received from those users, and characteristics of the users who supplied the negative signal. For example, consider an advertisement that is displayed to fifty men and fifty women of mixed age, ethnicity, location of residence, and political and religious views, as described in each user's profile. A subset of the one hundred users supplies a negative signal associated with the advertisement, such as nine females and one male. In this example, the advertisement augmentation module 515 associates the attribute “female” with nine incidents of hiding and 41 incidents of not hiding, while the attribute “male” is associated with one incident of hiding and 49 incidents of not hiding. Various other user characteristics may be similarly tallied. If the advertisement is presented to N users having a given attribute, out of which x users hide the advertisement, the advertisement augmentation module 515 calculates a ratio of x/N. The advertisement augmentation module 515 compares the ratio to a threshold α. If x/N>α, the advertisement augmentation module 515 determines that the attribute characterizes the set of users who are uninterested in the advertisement. Similarly, the advertisement augmentation module 515 can determine an attribute characterizing the set of users who are interested in (or neutral towards) an advertisement by comparing (N−x)/N to a second threshold β, where β≦α. If (N−x)/N>β for a given user attribute and advertisement, the advertisement augmentation module 515 determines that users having the attribute are interested in or neutral towards the advertisement.

In another embodiment, the advertisement augmentation module 515 determines attributes shared by each group of users by machine learning. A method for generating user models for targeting similar users of a social networking system is described in “Generating Clusters of Similar Users for Advertisement Targeting,” U.S. patent application Ser. No. 13/297,117, filed Nov. 15, 2011, which is incorporated by reference in its entirety. According to the method described in this application, a set of users to whom the advertisement is shown can be used as a training set for the machine learning algorithm. The advertisement augmentation module 515 identifies the users who supplied explicit negative feedback for the advertisement as having one or more defining characteristics. The users who view the advertisement but do not supply explicit negative feedback are identified as not having the defining attributes. The advertisement augmentation module 515 trains a machine learning algorithm using the training set comprising the two groups of users.

A number of user characteristics can be used as features for training the learning algorithm, such as demographic characteristics, keywords listed in user profiles, and connections of users within the social networking system. In one embodiment, the advertisement augmentation module 515 filters the users in the training set prior to training the learner, based on the number of times a user has supplied explicit negative feedback. If a user hides more than a predefined percentage of the advertisements displayed to the user, the user is not included in the training set or is assigned a lower weight than other users. For example, a user who hides most of the advertisements that are displayed to him may be hiding the advertisement because it is an advertisement, and not because he particularly dislikes the content of the advertisement. Filtering the users in this manner refines the algorithm by removing false negatives in the data set.

The machine learning algorithm can be used to identify other users of the social networking system that are similar to the two groups of the training set. In particular, the advertisement augmentation module 515 uses the learning algorithm to determine a cluster of users to whom the advertisement was not previously delivered, who share one or more characteristics with the group of users who provided explicit negative feedback. By clustering users based on common characteristics, the advertisement augmentation module 515 identifies a set of users who are most likely to be uninterested in the advertisement. In one embodiment, the advertisement augmentation module 515 determines the quality score for the advertisement indicating the likelihood that a user in the cluster of users will have a positive interaction with the advertisement. Positive interaction may include, for example, the user clicking on a link in the advertisement, requesting more information about the object associated with the advertisement, or completing a financial transaction for a product described in the advertisement.

When determining whether to deliver the advertisement to a target user, the social networking system 100 determines whether a user is in the cluster of users likely to be uninterested in the advertisement. If the target user is in the set, the social networking system 100 reduces the rate at which the advertisement is presented to the target user, but if the target user is not in the set the presentation rate is increased. In one embodiment, the rate of presentation is reduced or increased based on the quality score of the advertisement.

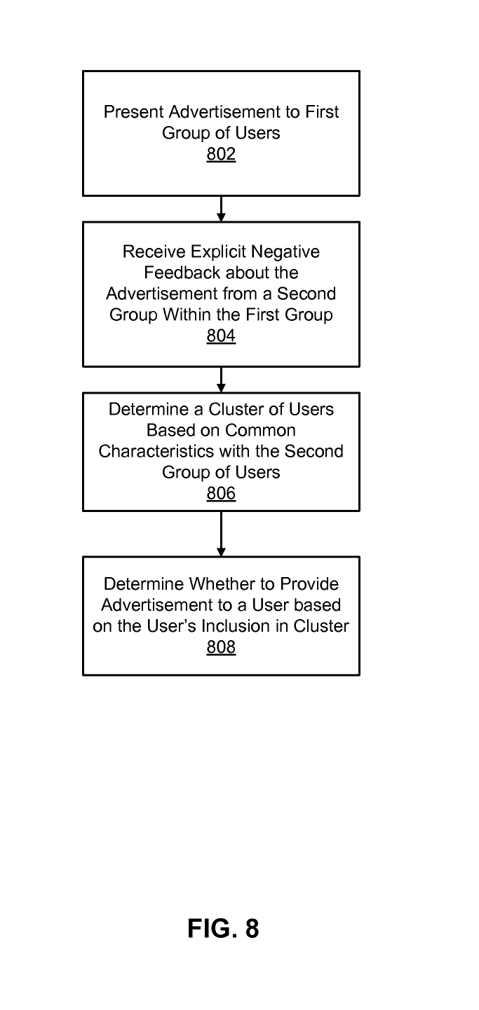

FIG. 8 is a flowchart illustrating a method for determining a cluster of users who dislike an advertisement based on negative feedback associated with the advertisement. The advertisement is presented 802 to a first group of users. Explicit negative feedback about the advertisement is received 804 from a second group of users, comprising a subset of the first group of users. Responsive to receiving the negative feedback, the social networking system 100 determines one or more characteristics of the users in the second group and uses the characteristics as a training set for a machine learning algorithm. A cluster of users outside of the first group is determined 806, based on common characteristics that the users in the cluster share with the second group of users. The social networking system 100 determines 808 whether to provide an advertisement to a user in the cluster of users based at least in part on the user's inclusion in the cluster.

### Selection of Reasons

In one embodiment, the reasons module 520 chooses reasons to include in the set of reasons presented to users based on the reasons previously selected by users. As users provide explicit negative feedback for an advertisement, the reasons module 520 receives user selections of reasons and analyzes the responses. If users predominantly choose one reason or one type of reason for disliking a particular advertisement, the reasons module 520 modifies the set of reasons to more precisely characterize the predominant reason.

In one embodiment, the reasons module 520 determines that a reason is a predominantly-chosen reason based on a statistical analysis of users' selections. For example, after presenting a number of reasons to users and receiving selections from among those presented, the reasons module 520 may use analysis of variance (ANOVA) to determine if one or more of the reasons is selected more frequently than the others and a post hoc test to identify the frequently-selected reason. Alternatively, the reasons module 520 may determine the reason for users' dislike of the advertisement based on a comparison of the received responses to a threshold E. If N users each select one reason for disliking an advertisement, out of which a responses are reason X, the reasons module 520 determines a ratio of a/N. If a/N>ε, the reasons module 520 determines that the advertisement is predominantly disliked for reason X.

If a particular reason or category of reason is selected more frequently than other reasons, the reasons module 520 in one embodiment modifies the set of reasons presented to users to include more specific reasons for disliking the advertisement. In one embodiment, the reasons module 520 selects the reasons of the modified set based on whether previous users predominantly chose advertisement-specific reasons or user-specific reasons. If the predominant reasons were user-specific reasons, the reasons module 520 selects more user-specific reasons to include in the modified set. If the predominant reasons were advertisement-specific reasons, the reasons module 520 selects more advertisement-specific reasons to include in the modified set.

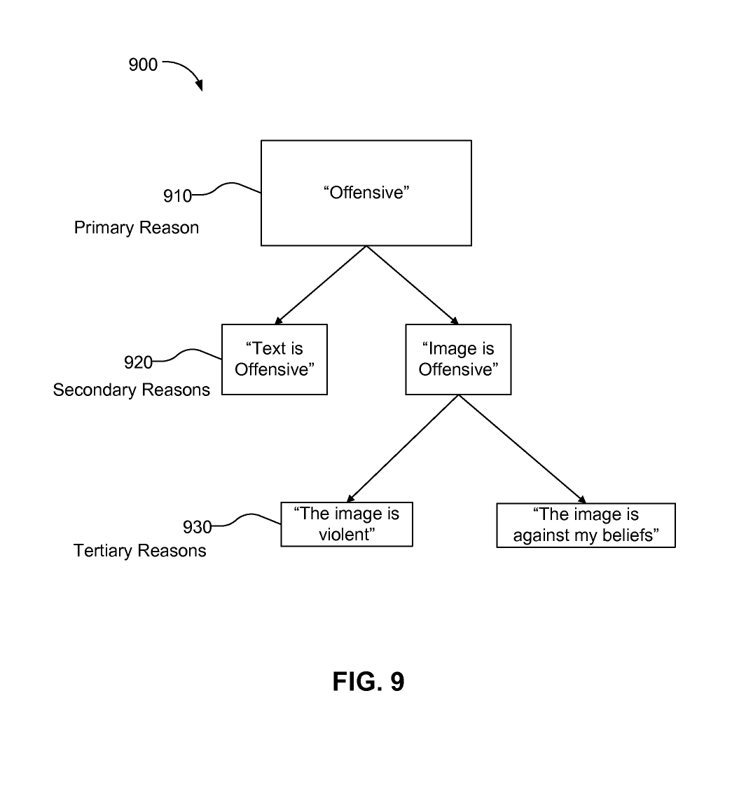

In another embodiment, the reasons module 520 selects the reasons of the modified set from the reasons store 530 based on predefined associations of the reasons, such as a hierarchy of specific reasons that correspond to more general reasons for disliking an advertisement. An example of a hierarchy of reasons is illustrated in FIG. 9. The reason hierarchy 900 defines an association between the reasons in the reason store 530. A subset of the reasons may be classified as primary reasons 910. For example, the reasons 620 illustrated in FIG. 6 may be classified as primary reasons offering generic explanations for users disliking the advertisement. Each primary reason may be associated with one or more secondary reasons 920 that offer a more specific explanation for why a user provided explicit negative feedback. Similarly, each secondary reason 920 may be associated with one or more tertiary reasons 930 offering even more specific explanations for the negative feedback, and so on.

In one embodiment, the reasons module 520 selects a set of primary reasons 910 to present to the first users providing explicit negative feedback for a particular advertisement. If users predominantly select a particular primary reason 910 for the negative feedback, the reasons module 520 selects secondary reasons corresponding to the predominant primary reason to include in sets of reasons presented to subsequent users. For example, if most users who provide negative feedback select “offensive” as the reason for their disliking the advertisement, the reasons module 520 may present subsequent users with secondary reasons 920 such as “The image is offensive” and “The text is offensive.” As an increasing number of users provide negative feedback and select reasons for the feedback, the reasons module 520 may further refine the set of reasons presented to users. For example, if “The image is offensive” is chosen by a threshold or statistically-significant number of users, the reasons module 520 may present tertiary reasons 930 describing why the image is offensive, such as “The image is violent” or “The image is against my beliefs.”

By modifying the set of reasons presented to users based on previously-selected reasons, the social networking system 100 can acquire a vast store of knowledge about an advertisement without causing significant user inconvenience. Although each user who provides negative feedback selects only one reason (or a small number of reasons) for disliking an advertisement, the reasons selected by many users over a period of time can provide a detailed characterization of an advertisement.

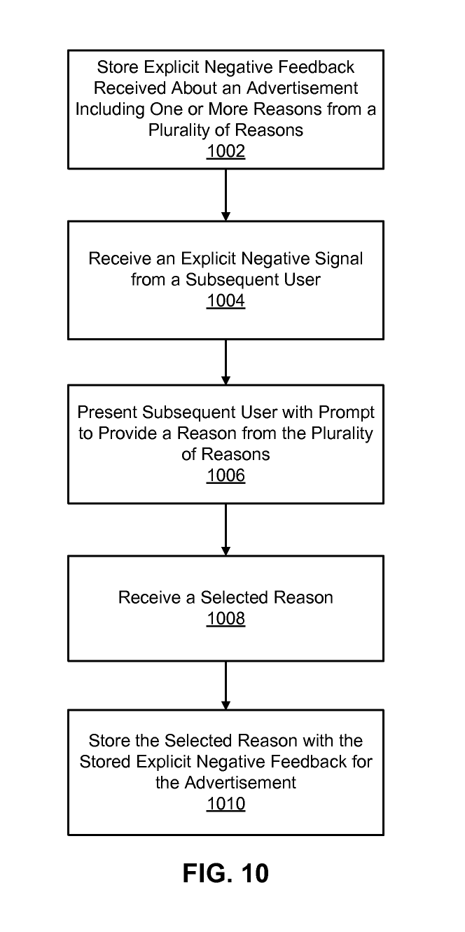

FIG. 10 is a flowchart illustrating a method for determining detailed reasons for users disliking an advertisement, according to one embodiment. The social networking system 100 stores 1002 explicit negative feedback received about an advertisement. The explicit negative feedback includes one or more reasons for the negative feedback that were selected by the users who provided the feedback, out of a plurality of possible reasons stored by the social networking system 100. When an explicit negative signal for the advertisement is received 1004 from a subsequent user, the social networking system 100 presents 1006 the subsequent user with a prompt to provide a reason for the negative feedback. The prompt includes a subset of the plurality of reasons stored by the social networking system 100, selected based on the negative feedback received from previous users. The social networking system 100 receives 1008 a selection of reason from the subsequent user, and stores 1010 the subsequent user's negative feedback and selected reason.

### Component Identification

In one embodiment, the advertisement augmentation module 515 determines a quality score for an advertisement based on the components of the advertisement. When a user supplies negative feedback for an advertisement, the set of reasons displayed to the user gives the user the opportunity to identify a particular component of the advertisement as the reason for disliking the advertisement. The advertisement augmentation module 515 identifies other advertisements that have the same component, and decreases the quality score of the other advertisements based on the negative feedback.

The reasons module 520 sends a list of components, such as title, text, image, link, or structured data representing objects maintained by the social networking system 100, for display to users who provide negative feedback for an advertisement. For example, the list of components may be presented as the list of reasons 620 in FIG. 6. After receiving user selections, the reasons module 520 identifies the components of an advertisement by performing a statistical analysis, such as an ANOVA, on the reasons selected by users. If one component is selected as being the reason for users disliking the advertisement a statistically significantly higher number of times, the reasons module 520 identifies the component as causing user dislike.

The advertisement augmentation module 515 uses the identified component to determine quality scores for other advertisements. For example, users may indicate that the text of a particular advertisement cause them to dislike the advertisement. In response, the advertisement augmentation module 515 may decrease the quality scores of other advertisements in the advertisement store 130 that have text. The scores of the other advertisements may be decreased by a fixed amount (e.g., 0.5) or by a ratio (e.g., multiply the score by 75%).

Alternatively, the amount by which a quality score is decreased may be determined based on whether the user disliked the component for an advertisement-specific reason or for a user-specific reason. After a user indicates a particular component that caused the user to dislike the advertisement, the reasons module 520 presents to the user one or more reasons for the explicit negative feedback associated with the component and receives a selection of one of the reasons. Each of the reasons for disliking a component may be categorized as being user-specific, advertisement-specific, or both. If the selected reason is advertisement-specific, the advertisement augmentation module 515 decreases the quality score of advertisements having the component. In contrast, if the user selects a reason that is user-specific, the advertisement augmentation module 515 may not adjust the quality score of other advertisements having the component. In one embodiment, the user profile augmentation module 510 adds the component to the user's negative interests list when the reason is user-specific.

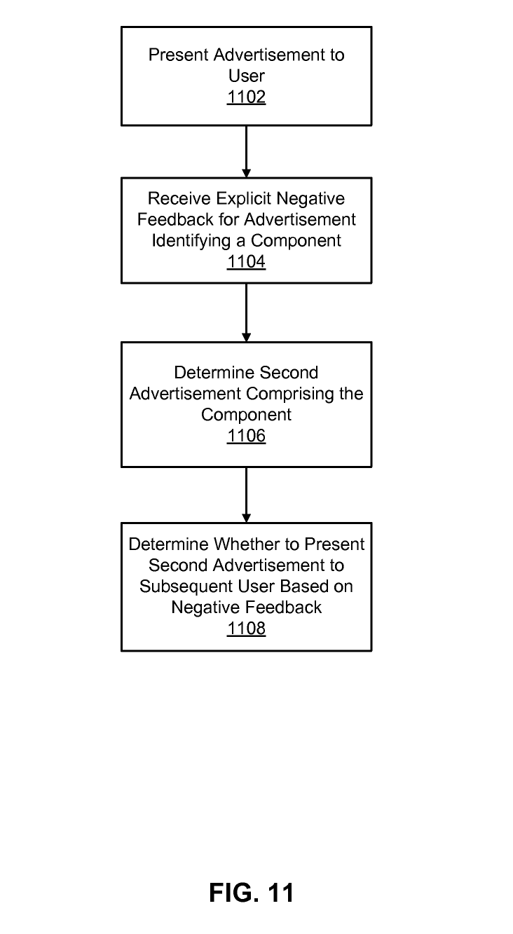

FIG. 11 is a flowchart illustrating a method for generating a quality score for an advertisement based on another advertisement's components and using the quality score to determine whether to deliver the advertisement to a user. A first advertisement is presented 1102 to a user, and explicit negative feedback for the first advertisement is received 1104 from the user. In one embodiment, the social networking system 100 presents a set of reasons to users who provide explicit negative feedback, requesting the users to identify a component that is the cause for the feedback. The social networking system 100 determines 1106 a second advertisement that has the identified component, and calculates a quality score for the second advertisement based at least in part on its having the component. Using the quality score, the social networking system 100 determines 1108 whether to present the second advertisement to a subsequent user.

### Alternative Configuration Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method comprising:
sending, by a computer, an advertisement for presentation to a user, the user associated with a user profile;
receiving a negative signal for the advertisement, wherein the negative signal comprises one or more reasons corresponding to a possible cause for the negative signal, each reason categorized as one or more of a user-specific reason and an advertisement-specific reason;
responsive to the one or more reasons being user specific, augmenting the user profile of the user indicating dislike for a topic related to the advertisement; and
responsive to the one or more reasons being advertisement specific, augmenting the advertisement with a negative attribute.

2. The computer-implemented method of claim 1, wherein augmenting the user profile comprises determining one or more topics related to the advertisement and adding the topics to a negative interests list for the user profile.

3. The computer-implemented method of claim 2, further comprising:
responsive to another advertisement being related to the one or more topics added to the negative interests list, reducing the rate at which the other advertisement is presented to the user.

4. The computer-implemented method of claim 1, wherein augmenting the advertisement comprises determining a quality score for the advertisement based at least in part on the negative feedback.

5. The computer-implemented method of claim 1, wherein augmenting the advertisement comprises associating the negative feedback with the advertisement.

6. The computer implemented method of claim 1, wherein the one or more reasons include whether the advertisement is uninteresting, whether the advertisement is misleading, whether the advertisement is sexually explicit, and whether the advertisement is offensive.

7. The computer implemented method of claim 1, further comprising:
responsive to augmenting the advertisement with negative attribute, reducing the rate at which the advertisement is sent to other users.

8. The computer implemented method of claim 1, further comprising:
responsive to augmenting the advertisement with negative attribute, reducing the rate at which the advertisement to sent to a set of users categorized as having dislike for advertisements with the negative attribute.

9. The computer implemented method of claim 1, further comprising:
receiving information from the user providing explicit negative feedback for advertisements associated with an entity.

10. The computer implemented method of claim 9, further comprising:
responsive to the selected reason being advertisement specific, augmenting a representation of the entity with a negative attribute.

11. The computer implemented method of claim 10, further comprising:
responsive to augmenting the representation of the entity with a negative attribute, reducing a rate at which advertisements associated with the entity are presented to other users.

12. The method of claim 1, wherein the negative signal is explicit negative feedback received from the user.

13. The computer implemented method of claim 12, further comprising:
responsive to the explicit negative feedback from the user, reducing the rate at which the advertisement is presented to the user.

14. The method of claim 1, further comprising:
presenting to the user, a prompt to provide a reason for the negative signal.

15. The method of claim 1, further comprising:
receiving from the user a selection a reason for the negative signal.

16. A non-transitory computer-readable storage medium storing executable computer program instructions, the computer program instructions comprising instructions for:
sending, by a computer, an advertisement for presentation to a user, the user associated with a user profile;
receiving a negative signal for the advertisement, wherein the negative signal comprises one or more reasons corresponding to a possible cause for the negative signal, each reason categorized as one or more of a user-specific reason and an advertisement-specific reason;
responsive to the one or more reasons being user specific, augmenting the user profile of the user indicating dislike for a topic related to the advertisement; and
responsive to the one or more reasons being advertisement specific, augmenting the advertisement with a negative attribute.

17. The computer-readable storage medium of claim 16, wherein augmenting the user profile comprises determining one or more topics related to the advertisement and adding the topics to a negative interests list for the user profile.

18. The computer-readable storage medium of claim 17, the instructions further comprising instructions for:
responsive to another advertisement being related to the one or more topics added to the negative interests list, reducing the rate at which the other advertisement is presented to the user.

19. The computer-readable storage medium of claim 16, wherein augmenting the advertisement comprises determining a quality score for the advertisement based at least in part on the negative feedback.

20. The computer-readable storage medium of claim 16, wherein augmenting the advertisement comprises associating the negative feedback with the advertisement.

21. The computer-readable storage medium of claim 16, wherein the one or more reasons include whether the advertisement is uninteresting, whether the advertisement is misleading, whether the advertisement is sexually explicit, and whether the advertisement is offensive.

22. The computer-readable storage medium of claim 16, the instructions further comprising instructions for:
responsive to augmenting the advertisement with negative attribute, reducing the rate at which the advertisement is sent to other users.

23. The computer-readable storage medium of claim 16, the instructions further comprising instructions for:
responsive to augmenting the advertisement with negative attribute, reducing the rate at which the advertisement to sent to a set of users categorized as having dislike for advertisements with the negative attribute.

24. The computer-readable storage medium of claim 16, the instructions further comprising instructions for:
receiving information from the user providing explicit negative feedback for advertisements associated with an entity.

25. The computer-readable storage medium of claim 24, the instructions further comprising instructions for:
responsive to the selected reason being advertisement specific, augmenting a representation of the entity with a negative attribute.

26. The computer-readable storage medium of claim 24, the instructions further comprising instructions for:
responsive to augmenting the representation of the entity with a negative attribute, reducing a rate at which advertisements associated with the entity are presented to other users.

27. The computer-readable storage medium of claim 16, wherein the negative signal is explicit negative feedback received from the user.

28. The computer-readable storage medium of claim 27, the instructions further comprising instructions for:
responsive to the explicit negative feedback from the user, reducing the rate at which the advertisement is presented to the user.

29. The computer-readable storage medium of claim 16, the instructions further comprising instructions for:
presenting to the user, a prompt to provide a reason for the negative signal.

30. The computer-readable storage medium of claim 16, the instructions further comprising instructions for:
receiving from the user a selection a reason for the negative signal.

31. A method comprising:
sending by a computer a first advertisement for display to a user of an online system;
receiving a negative signal for the first advertisement, the negative signal identifying a component of the advertisement with which the user has a negative association;
determining a second advertisement that comprises the component identified by the negative feedback; and
determining whether to provide the second advertisement to a subsequent user of the online system based at least in part on the negative feedback associated with the component.

32. The method of claim 31, wherein a component of an advertisement includes an image, a link to a webpage, a text portion, or a title.

33. The method of claim 31, further comprising:
sending for presentation to the user, information describing one or more components of the first advertisement and a request for the user to identify the component with which the user has the negative association; and
receiving from the user, a selection of component from the one or more components.

34. The method of claim 31, further comprising:
sending one or more reasons for presentation to the user, each reason corresponding to a possible cause for the negative association with the component; and
receiving a selection of reason from the one or more reasons sent to the user.

35. The method of claim 34, wherein each reason is categorized as one or more of a user-specific reason and an advertisement-specific reason.

36. The method of claim 35, further comprising:
responsive to the selected reason being user-specific, augmenting a user profile of the user to indicate dislike for the component with which the user has the negative association.

37. The method of claim 35, further comprising:
responsive to the selected reason being advertisement-specific, augmenting the component with which the user has the negative association with a negative attribute.
